(19) United States
(12) Patent Application Publication
(10) Pub. No.: US 2009/0101714 A1
(43) Pub. Date: Apr. 23, 2009

(54) Inventory management method for lottery tickets

(75) Inventors: Edward H. Weyler, III, Elizabeth, IN (US); Nell P. Weyler, Elizabeth, IN (US)

Correspondence Address: H. JAY SPIEGEL - H. JAY SPIEGEL & ASSOCIATES, P.O. BOX 11, MOUNT VERNON, VA, 22121, US

(73) Assignee: Lottery Works, Incorporated

(21) Appl. No.: 11/975,560

(22) Filed: Oct. 22, 2007

(51) Int. Cl. G06F 19/00

(52) U.S. Cl. 235/385

(57) ABSTRACT

The method is conducted concerning scratch-off tickets having a plurality of regions coated with a substance that may be scratched off to reveal whether the ticket holder is a winner. Such a ticket has its own unique identifier such as a bar code. The method includes software that operates off of the bar code located on each ticket. When a book of tickets has been received by a retailer, the method is employed to create a record for each book of tickets received. Once tickets have been activated, the method includes the step of recording the fact that the book has been activated and is now ready for sale. The method permits full inventory control of all aspects of ticket receipt, storage, activation, sale, accounting and even voiding, where necessary.

### BACKGROUND OF THE INVENTION

The present invention relates to an inventory management method for lottery tickets. In convenience stores and other retail establishments, one lucrative profit center is that of sales of lottery tickets of various kinds. As lucrative as such sales might be, it is equally true that the area of lottery sales is fraught by potential fraud and theft. In this regard, the biggest source of fraud and theft is the employees of the retail establishment. Books of lottery tickets once activated have some of the vestiges of actual currency. In any given pack of lottery tickets, there is likely to be at least one or several winning tickets that can be redeemed for cash. This is particularly true concerning scratch-off-type tickets in which the purchaser uses the edge of a coin or other hard object to scratch a coating off different areas on the card to reveal matching letters, numbers and/or symbols that result in a winning ticket.

In Kentucky, for example, scratch-off tickets are commonly sold under the aegis of the Kentucky State Government. Retailers are licensed to be outlets for those scratch-off tickets, and typically purchase them from the State agency in packs or books.

For example, a single pack or book of scratch-off tickets may include up to 300 tickets. Each ticket typically includes a bar code with at least 12 numbers represented. In one example, the first three numbers identify the number of the particular game that is being played. The next six digits identify the specific book number in question, and the final three numbers represent the specific ticket numbers. Thus, the last three digits might be numbered from 000 to 299.

A retailer may purchase books of tickets from the State agency, but those tickets may not be sold until they are electronically activated using a communication means between the retailer and the State agency. Once a book of tickets has been activated, the individual tickets contained therein may be sold to customers of the retail establishment.

The retailer may sell the tickets in any number of ways such as in a vending machine and across one or more counters within the retail establishment. It would be helpful to the retailer to be able to keep track of where in their retail establishment each ticket is located and to be able to keep track of when each ticket has been sold, when each ticket has been activated, and how many tickets remain in each book, among other pieces of information.

It would also be helpful to the retailer if such accounting would preclude, deter or prevent fraud including that which is caused by employee and customer theft. It is with these thoughts in mind that the present invention was developed.

### SUMMARY OF THE INVENTION

The present invention relates to an inventory management method for lottery tickets. The present invention includes the following interrelated objects, aspects and features:

(1) In a first aspect of the present invention, in the preferred embodiment thereof, the inventive inventory management method is intended to be conducted concerning scratch-off tickets. Such tickets have a plurality of regions thereon coated with a substance that may be scratched off with a sharp object such as a coin or a scraper provided for that purpose. Once the coating has been scratched off the ticket, the purchaser can determine whether the ticket is a winner or loser.

(2) Such a scratch-off ticket includes its own unique identifier such as a bar code depicting a series of numbers in a prescribed sequence. For example, the bar code may include numbers corresponding to the precise game played by the ticket, the identification of a book of tickets in which the particular ticket is located, and a particular ticket number within that booklet. Other information may, if desired, be provided on the identifier for the ticket.

(3) When a retailer receives books of tickets, often the tickets are received before a date of activation of the game for which the tickets have been manufactured. The retailer is provided a communication means with which to communicate with the State agency so that tickets may be activated to permit their sale after the game for which the tickets were manufactured has been activated. Until the tickets are activated, they are the property of the State agency. Once they have been activated, the retailer assumes the responsibility to sell the tickets and pay the agency for tickets that have been activated.

(4) The inventive inventory management method includes the provision of software that, in one preferred embodiment, operates off of the unique identifier such as the bar code located on each ticket. When a book of tickets has been received by the retailer, even before it is activated with the State agency, the inventive method is employed to create a record for each book of tickets received. Once tickets have been activated, the inventive method includes the step of recording the fact that the book has been activated and is now ready for sale.

(5) Books of tickets are moved to desired locations within the retail establishment such as at a vending machine or at one or more different counters within the retail establishment. The software is programmed to provide files for each such location so that when each ticket and each book of tickets is moved to various locations within the retail establishment, a record is made of the specific location of each ticket and each book of tickets.

(6) As tickets are sold, their bar codes may be scanned in accordance with the teachings of the present invention to keep track of the number of tickets sold. Alternatively, presuming each ticket in a book is sold in consecutive order, at the end of each business day, the last ticket may be scanned and the software may be programmed to assume that each ticket having a ticket number before the number of the tickets scanned has been sold. With this information, accounting may be recorded concerning the number of tickets sold at each location.

(7) As explained above, once a book of tickets has been activated via the State agency, the retailer becomes obligated to pay the retailer's cost for the activated tickets. The software may be programmed to keep track of due dates for payments for tickets so that the retailer may have better control over their cash flow and not pay for tickets too far in advance of when payment is due. Thus, for example, if the term of payment is net 30, the software may include the feature of notifying the retailer on the 25^{th} day so that the retailer knows payment must be received by the State agency within the next five days.

(8) As another feature of the present invention, the software may include the aspect that periodically including at the end of each business day inquiries are made of the retailer concerning a variety of books of tickets and concerning questions the retailer needs to have answered to keep track of inventory. Thus, for example, one hour before closing time, the software may be programmed to provide a “flag” to the retailer asking a number of questions including (a) how many tickets have been sold in each location, (b) whether the retailer can account for each book of tickets received, (c) whether the retailer can account for every book of tickets activated, (d) whether the retailer is aware of the due dates coming up for payment for sold and activated lottery tickets with payment being required to be made to the State agency.

(9) The inventive method may also include programming of the software to keep track of tickets that the retailer wishes to return because they were unsold and the game for which they were manufactured is no longer in play.

(10) Often, to help promote the retailer's business, the retailer may donate tickets to a charity to be given away as a prize. The inventive method may include programming the software to account for tickets that have been given away during such promotions.

Accordingly, it is a first object of the present invention to provide an inventory management method for lottery tickets.

It is a further object of the present invention to provide such a method operated on lottery tickets using a bar code-type identifier.

It is a still further object of the present invention to provide such a method in which the user may keep track of lottery tickets that are received from a State agency, whether activated or not.

It is a yet further object of the present invention to provide such a method in which the retailer may keep track of the locations of tickets at a variety of locations within a retail establishment such as vending machines as well as retail sales counters.

It is a still further object of the present invention to provide such a method in which the retailer may keep track of the number of tickets sold on any given day or time period as well as at each location within the retail establishment.

It is a yet further object of the present invention to provide such a method in which payment schedules for activated tickets may be saved with periodic notifications being given to the retailer.

It is a yet further object of the present invention to provide such a method in which expired tickets to be returned are monitored.

It is a still further object of the present invention to provide such a method in which tickets donated for charitable or other non-profit purposes are accounted for in a different way since they are not sold.

These and other objects, aspects and features of the present invention will be better understood from the following detailed description of the preferred embodiments when read in conjunction with the appended drawing figures.

### BRIEF DESCRIPTION OF THE DRAWINGS

FIG. 1 shows a representation of the front of a scratch-off lottery ticket.

FIG. 2 shows the rear face of the lottery ticket of FIG. 1.

FIG. 3 shows a schematic representation of the manner by which a master record is created for one particular game.

FIG. 4 shows a schematic representation of the manner by which the inventive method activates lottery cards.

FIG. 5 shows a schematic representation of a flowchart showing the manner by which the present invention reconciles records concerning vending machine sales of lottery cards.

FIG. 6 shows a schematic representation of a flowchart showing how the present invention keeps track of lottery cards that have not been sold and are going to be returned to the State agency.

FIG. 7 shows a schematic representation of a flowchart showing how the present invention acts to void a previously activated card.

FIG. 8 shows a schematic representation of a flowchart employed to add information to the master record in the nature of editing game data or adding a game to the master record.

FIG. 9 shows a schematic representation of a flowchart showing how the present invention keeps track of cards that have been donated to third parties for charity and promotional purposes.

FIG. 10 shows a schematic representation of a flowchart showing how the present invention sets up location codes to facilitate keeping track of lottery cards located at different locations in a retail establishment.

### SPECIFIC DESCRIPTION OF THE PREFERRED EMBODIMENTS

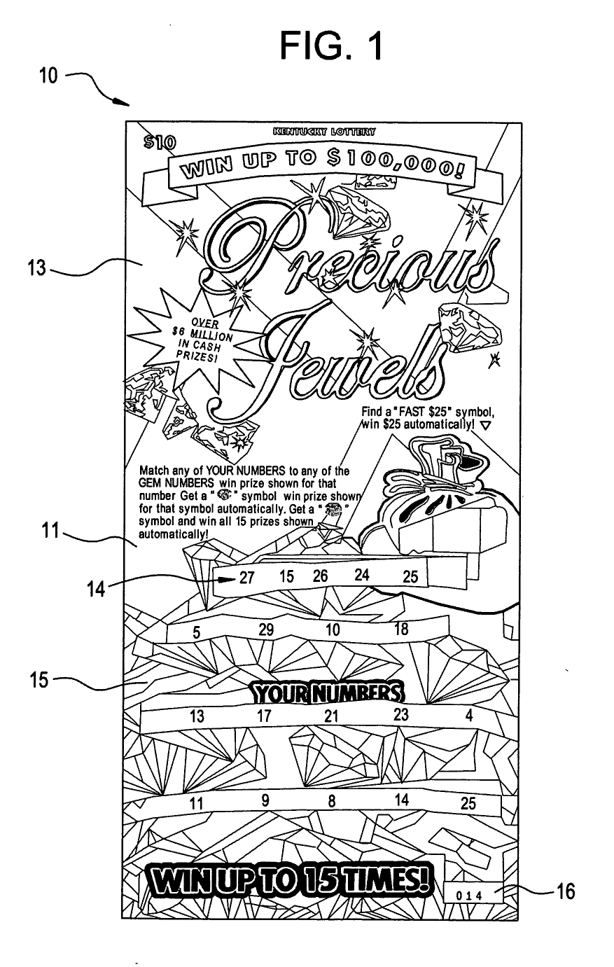

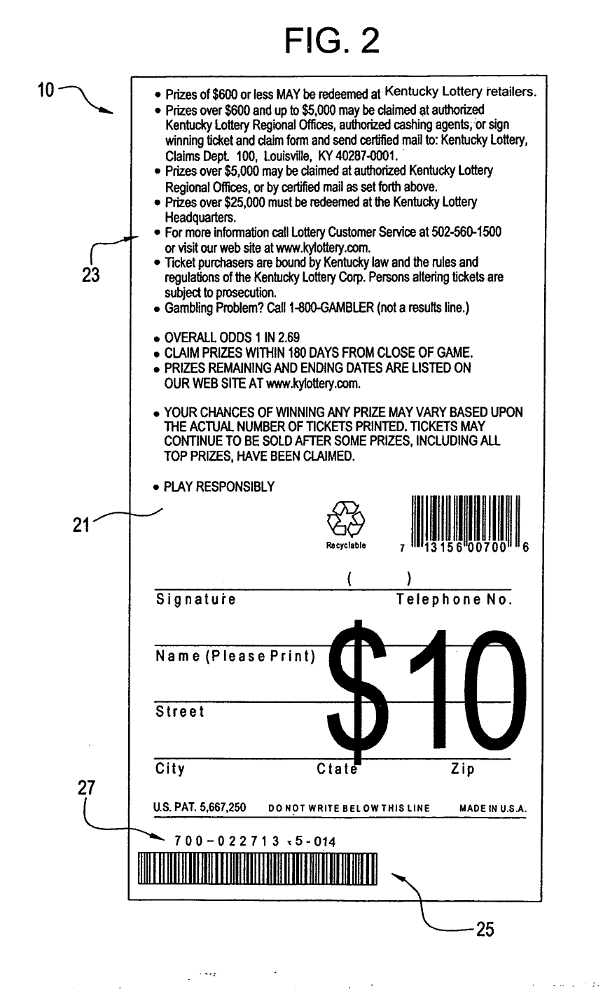

Reference is first made to FIGS. 1 and 2 which depict the front and rear surfaces, respectively, of a lottery card generally designated by the reference numeral 10. The front surface 11 includes the name 13 of the game, in the example shown “PRECIOUS JEWELS.” As seen on the front surface 11, a plurality of gems bear the numbers 27, 14, 26, 24 and 2. The object of the game is to scratch off those gems revealing the numbers described above and then scratch off the other numbers in the region 15 identified by the heading “YOUR NUMBERS.” Prizes are given for any number in the “YOUR NUMBERS” section that match with the gem numbers 14.

With reference to FIG. 2, the lottery card also includes a rear surface 21 that includes instructions 23 for collecting prizes, a bar code 25, and a series of numbers 27 above the bar code and stating the number generated in a computer when the bar code 25 is scanned.

In the example shown in FIG. 2, the series of numbers 27 includes the first three numbers “700” that tell a computer which game corresponds to the card, in this case, the “PRECIOUS JEWELS” game. The next six numbers, in the example shown “022713” describe the book number for the book containing the card shown in FIGS. 1 and 2. The last three digits “014” describe the actual card number shown. That same ticket number is designated by the reference numeral 16 in FIG. 1, and is shown in the lower right corner of the depiction of the card 10. Thus, when scanning the bar code 25 using a reader for that purpose, information may be retrieved as to the particular game, the book number, and the card number within the book. In accordance with the teachings of the present invention, these pieces of information, found by scanning the bar code 25, are used to keep track of the card 10 and all other cards within the book in which it is contained.

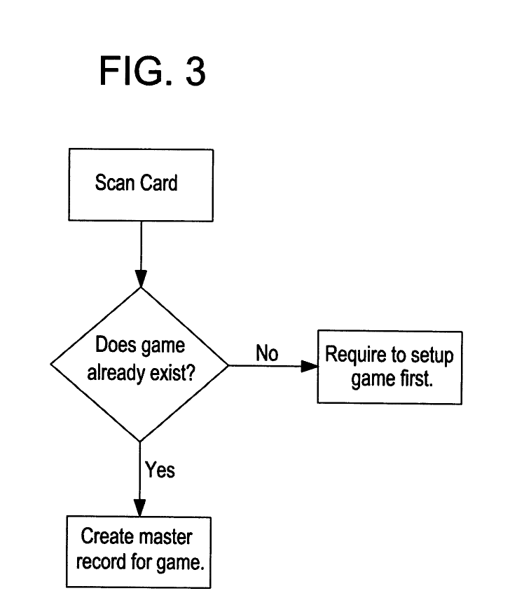

With reference to FIG. 3, the present invention contemplates a means by which a master record can be created for a game so that the retailer may keep track of all lottery cards they have received for that game. In the example shown in FIGS. 1 and 2, the game is “PRECIOUS JEWELS.” Thus, as shown in FIG. 3, a card may be scanned revealing to the computer that game number 700 corresponding to “PRECIOUS JEWELS” corresponds to that card. The program asks the question as to whether the game already exists. In this regard, the retailer often receives books of cards before a game has been activated by the State agency. Once the State agency has activated the game, it notifies all retailers via a communications network set up between the State agency and all of the retailers. The communications network may be via computer, telephone, or some combination of the two. The agency has a first system for keeping track of games it creates and implements. The first system keeps track of who has purchased cards, the status of payments for cards including due dates for payments as per agreements with retailers, starting and ending dates of games and of activation and de-activation of games as well as any other information concerning games and game cards. Cards may be sold once the retailer has received notification from the State agency that the game exists and has been activated. Information concerning each game is inputted into the retailer's computer and the game is set up. This can occur even before the game is activated by the State agency. A master record is created for the game, in this case, game 700 “PRECIOUS JEWELS,” and thus, when a card is scanned, the computer recognizes that a master record has been created, and the game has been set up.

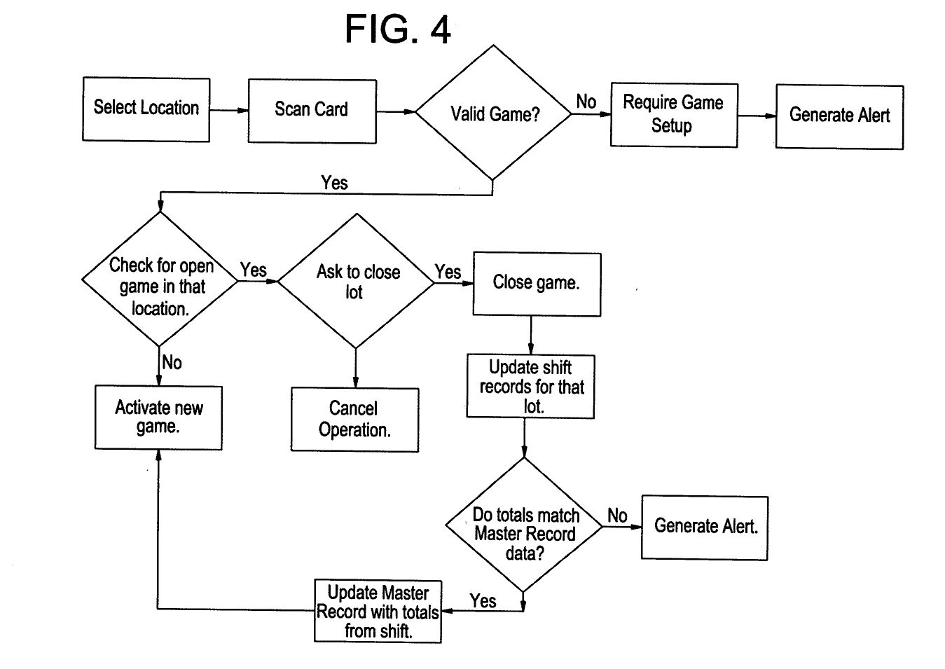

With reference to FIG. 4, the present invention includes a second system independent of the first system and including software for facilitating activation of cards and keeping track of where they are located. A location is selected and a card is scanned by a bar code reader. The question is asked as to whether the game is yet valid, in other words, whether the State agency has activated the game. This refers to a master record. A book is scanned by the bar code reader, the master record table has the game data and if the answer is yes, the game may proceed. If the record table does not have the game, the answer is no, and set up of the game must first occur. If the game is not set up, an alert is generated to facilitate reminding the retailer when the State agency has activated the game. If the game has been activated, the system checks to see whether an open game is at that location. At the conclusion of a time period in which the State agency decides to close the game, notification is given to the retailer who inputs that information into the system. Thereafter, lottery cards corresponding to that game may not be employed. Master records are periodically updated to reflect whether a game has been activated, whether a game has been closed, and to keep track of the inventory of cards corresponding to that game.

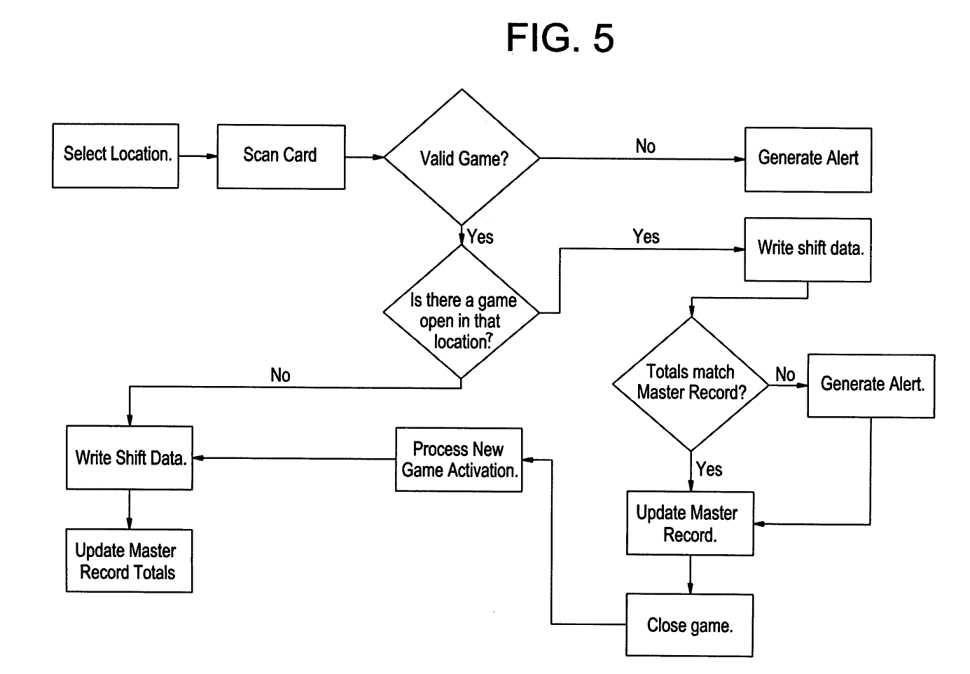

With reference to FIG. 5, as explained above, some retailers may sell lottery cards in vending machines. The flowchart of FIG. 5 describes how the second system operates to monitor remaining inventory within vending machines which may be reconciled through use of the present invention. Through scanning of bar codes, the total number of cards remaining in the vending machine may be ascertained, and that total is compared with the number of cards initially placed within the machine, to thereby enable determination of how many cards have been sold. In correlation with the flowchart shown in FIG. 4, when a game is closed by the State agency, and the retailer has been so notified, thereafter, none of the cards corresponding to that game may be sold.

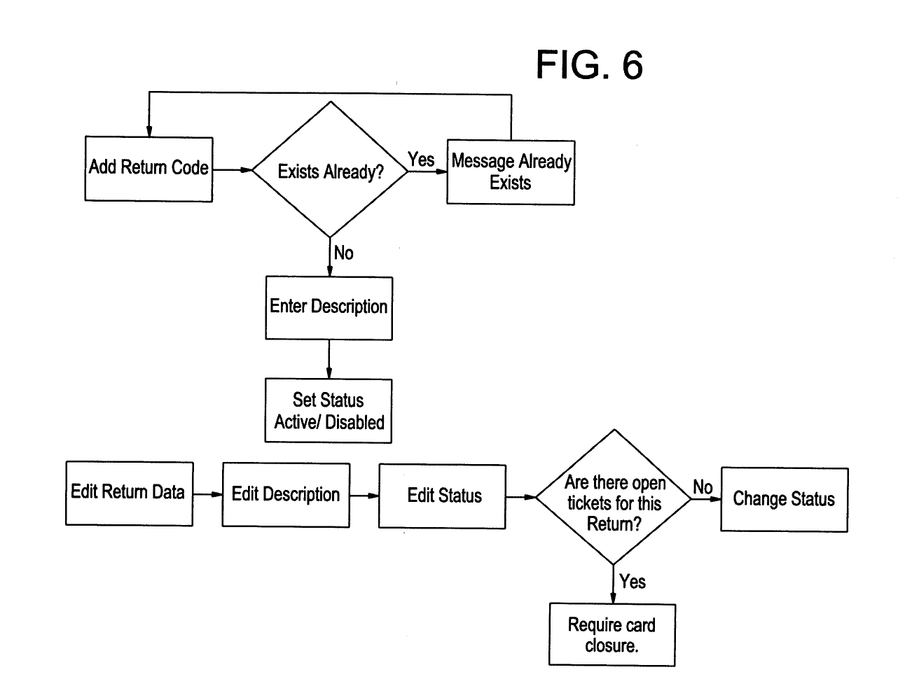

With reference to FIG. 6, when a game has been closed, unsold lottery cards corresponding to that game may be returned to the State agency for a refund or credit as against future lottery card purchases.

As explained in FIG. 6, a return code may be added by the second system to each card if it has not already been added, and a description of the card is entered, perhaps the numbering from the bar code corresponding to the game number, the book number, and remaining cards. Cards are closed out and records are created and maintained concerning those cards that were not sold and which were returned to the State agency.

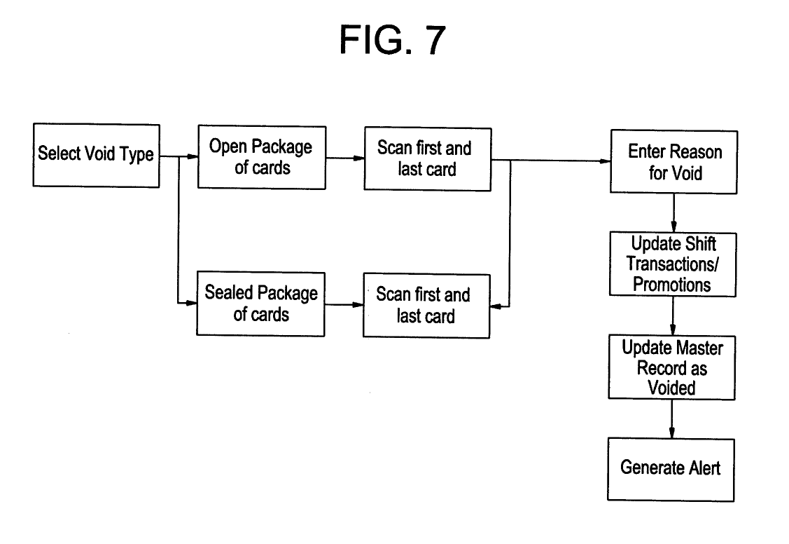

With reference to FIG. 7, there are occasions when a card or a book of cards might have to be voided by the retailer. Some of the reasons for voiding cards include (1) where a game has expired, (2) where a card or book of cards has been stolen, or (3) where a card or a plurality of cards within a book are in some fashion damaged or evidence visible tampering. With reference to FIG. 7, where a book of cards has been removed from its packaging, the first and last card are scanned, and codes are entered as preprogrammed into the system concerning the reason(s) why the card(s) is/are being voided. Shift transactions and promotions are updated and the master record is updated to reflect the voiding. An alert is generated as necessary to remind the retailer to either discard the voided card(s) or send it/them back to the State agency as required.

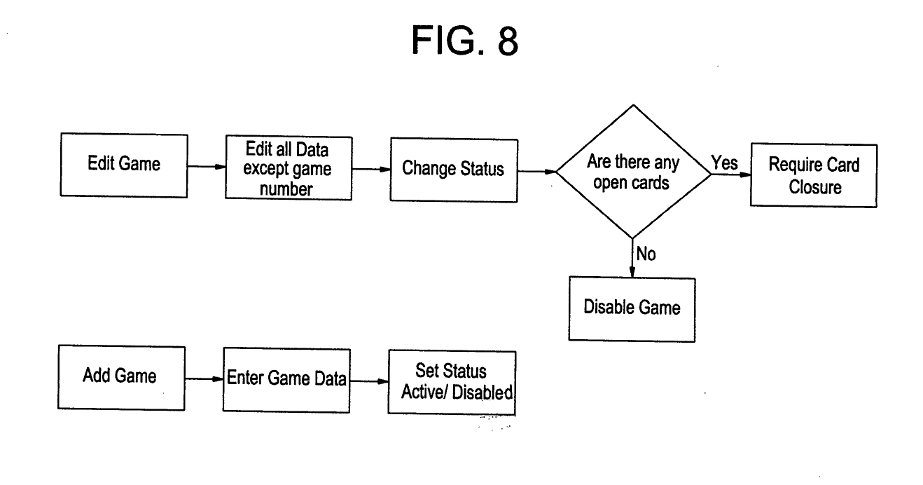

With reference to FIG. 8, there are occasions when the master records need to be updated and where additional games need to be added to the master record as they are created. Thus, in the example shown in FIGS. 1 and 2, game number 700 is the 700^{th} game created by the State agency. When that game is created and cards are printed and fabricated corresponding to that game, those cards are forwarded to the various retailers who will be selling them. When cards corresponding to a newly created game are received by the retailer, reference to those new games is added to the master record using the numbering system provided by the State agency. FIG. 8 shows the procedures followed for editing games and adding games to the master record.

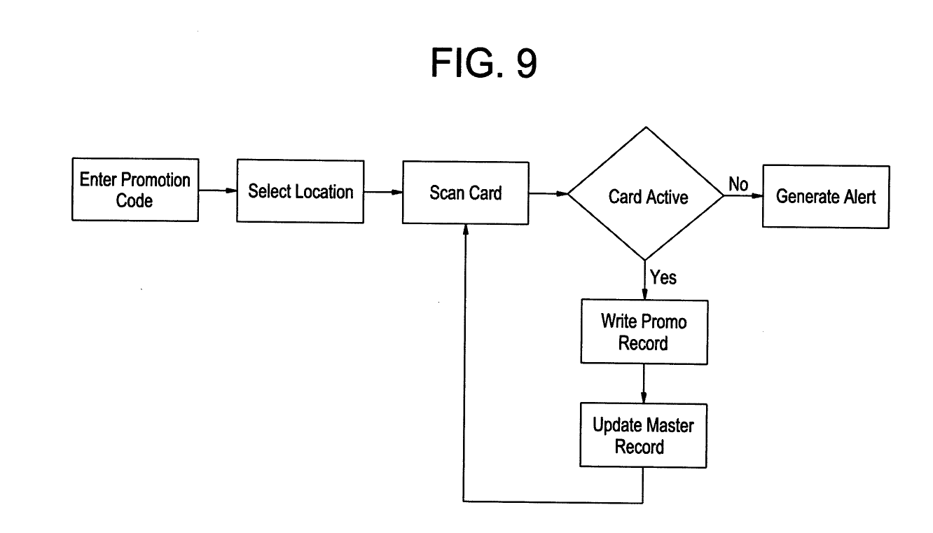

With reference to FIG. 9, as explained above, on occasion, cards or books of cards are donated to a charity or non-profit organization that will give away the cards with the hope that recipients will receive winning cards. In order to facilitate bookkeeping concerning this scenario, a promotion code is created by the second system for each such scenario, and when a particular scenario occurs, the correct promotion code is selected and entered. The location where the cards are initially stored is also entered so that the transaction can reflect removal of those cards from that location. Cards are scanned, verification is made that the cards are active, and if not, an alert is generated. If the cards are active, a promotional record is written and the master record is updated to reflect that those cards have been given away and will not be sold, although the retailer retains the responsibility to pay the State agency for those cards. Presumably, a tax deduction is generated for those donations. The master record may be updated to reflect the value of such donations and periodic notifications can be made so that the accountant for the retailer may be appropriately notified.

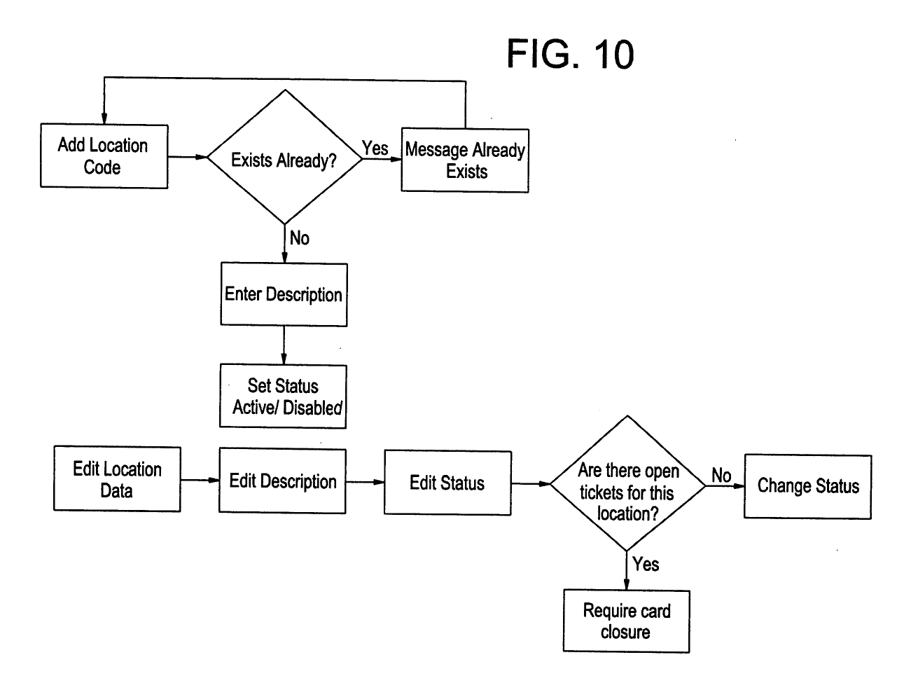

FIG. 10 shows the general procedure for setting up location codes by the second system within the retail establishment so that the retailer can keep track of the locations where cards are being stored and being sold. Location codes may be generated for such locations as (1) a storage closet or safe, (2) a vending machine where cards are to be placed for sale, and (3) sales counters throughout the retail establishment where books of cards may be located and sold.

As explained in FIG. 10, such location codes are created in the software and location data is entered corresponding to each card by scanning the bar codes on the cards. This information may be edited or modified as a card is sold or moved to another location or returned to the State agency as voided for a variety of reasons including damage, theft, or the end of a game.

With the present invention having been described as set forth above, it should now be understood that the present invention provides an effective way by which the retailer can keep track of every possible aspect of conducting the business of sales of lottery tickets. In accordance with the teachings of the present invention, the retailer may keep track of when cards are received, when games are activated, when cards are sold, the location where cards are sold including, for example, vending machines and retail sales counters, when cards are given away for promotion, and when cards are returned to the State agency for various reasons. The inventive method accompanied a system for practicing it permits the retailer to keep track of the due dates for payments for a variety of cards purchased by the retailer so that the retailer may keep track of cash flow requirements and not pay the State agency for cards purchased so early that cash flow is disrupted.

As such, an invention has been disclosed in terms of preferred embodiments thereof which fulfill each and every one of the objects of the invention as set forth hereinabove, and provide a new and useful inventory management method for lottery tickets of great novelty and utility.

Of course, various changes, modifications and alterations in the teachings of the present invention may be contemplated by those of ordinary skill in the art without departing from the intended spirit and scope thereof.

As such, it is intended that the preset invention only be limited by the terms of the appended claims.

1. A method of managing an inventory of games of chance by a store selling game cards for said games, each card having a unique identifier, including the steps of:
a) said store registering with an agency administering said games;
b) said agency operating a first system for keeping track of said games, said cards, status of games including amount of money paid out and dates of expiration, said first system also keeping track of payments received from said store for cards and activating and de-activating games and cards;
c) said store operating a second system independent of said first system, said second system using said unique identifier to monitor (1) inventory of cards received from said agency, (2) status of games corresponding to said cards including whether or not games are activated or expired, (3) location of cards within said store, (4) status of accounts payable, and (5) numbers of cards sold.

2. The method of claim 1, wherein said second system includes a reader for reading said unique identifier during said monitoring step.

3. The method of claim 2, wherein said unique identifier comprises a bar code.

4. The method of claim 1, wherein said agency comprises a governmental agency.

5. The method of claim 3, wherein said bar code corresponds to a series of numbers.

6. The method of claim 5, wherein at least one of said numbers corresponds to a particular game.

7. The method of claim 6, wherein at least one of said numbers corresponds to a book containing a plurality of cards.

8. The method of claim 7, wherein at least one of said numbers corresponds to a particular card.

9. The method of claim 1, wherein said location comprises any one of a vending machine or a retail sales counter.

10. The method of claim 1, wherein said cards comprise scratch-off game cards.

11. The method of claim 1, wherein said store comprises a retail convenience store.

12. The method of claim 7, wherein a book of cards includes more than 100 cards.

13. The method of claim 1, wherein said second system periodically conducts a check of inventory of cards including generation of a report detailing cards sold, revenues generated, and locations within said store where cards were sold.

14. The method of claim 3, wherein said reader comprises an electronic bar code reader.

15. The method of claim 13, wherein said second system reminds a store operator of deadlines for payments due said agency for purchases of cards.

16. The method of claim 13, wherein said second system tracks cards donated for charitable or non-profit purposes.

17. A method of managing an inventory of lottery games by a retail store selling scratch-off game cards for said games, each card having a unique bar code identifier, including the steps of:
a) said store registering with an agency administering said games;
b) said agency operating a first system for keeping track of said games, said cards, status of games including amount of money paid out and dates of expiration, said first system also keeping track of payments received from said store for cards and activating and de-activating games and cards;
c) said store operating a second system independent of said first system, said second system including means for reading said bar codes to monitor (1) inventory of cards received from said agency, (2) status of games corresponding to said cards including whether or not games are activated or expired, (3) location of cards within said store, (4) status of accounts payable, and (5) numbers of cards sold.

18. The method of claim 17, wherein said bar code corresponds to a series of numbers, at least one of said numbers corresponding to a particular game, at least one other number corresponding to a book containing a plurality of cards, and at least one further one of said numbers corresponding to a particular card.

19. The method of claim 17, wherein said second system periodically conducts a check of inventory of cards including generation of a report detailing cards sold, revenues generated, and locations within said store where cards were sold.

20. The method of claim 19, wherein said second system reminds a store operator of deadlines for payments due said agency for purchases of cards.
